(19) United States
(12) Patent Application Publication
(10) Pub. No.: US 2004/0017826 A1
(43) Pub. Date: Jan. 29, 2004

(54) Personalizable radio

(76) Inventors: Andreas Matthias Aust, Aldgate Court, NJ (US); Peter Steinborn, Lehrte-Arpke (DE); Ernst F. Schroder, Hannover (DE); Jens Spille, Hannover (DE); Jurgen Schmidt, Wunstorf (DE); Ulrich Schreiber, Garbsen (DE)

Correspondence Address: Joseph S Tripoli, Thomson multimedia Licensing Inc, Patent Operations CN 5312, Princeton, NJ, 08543-0028, US

(21) Appl. No.: 10/398,840

(22) PCT Filed: Sep. 29, 2001
(86) PCT No.: PCT/EP01/11294

(30) Foreign Application Priority Data
Oct. 11, 2000 (DE) 100-50-536.8

(51) Int. Cl. H04J 3/16

(52) U.S. Cl. 370/468; 370/486

(57) ABSTRACT

So that listeners can compile their radio service on an individual basis, broadcasts are classified according to the respective information content, and the broadcasts in each information class are sent in a respective data stream at parallel times. At the reception end, the data streams are simultaneously picked up, are possibly buffer-stored, and are forwarded to a reproduction device according to individual stipulations.

The present invention relates to a transmission apparatus for transmitting radio information and to a reception apparatus for receiving and conditioning radio information, in which a radio service can be compiled on an individual basis. The present invention also relates to appropriate methods for transmitting and receiving radio information.

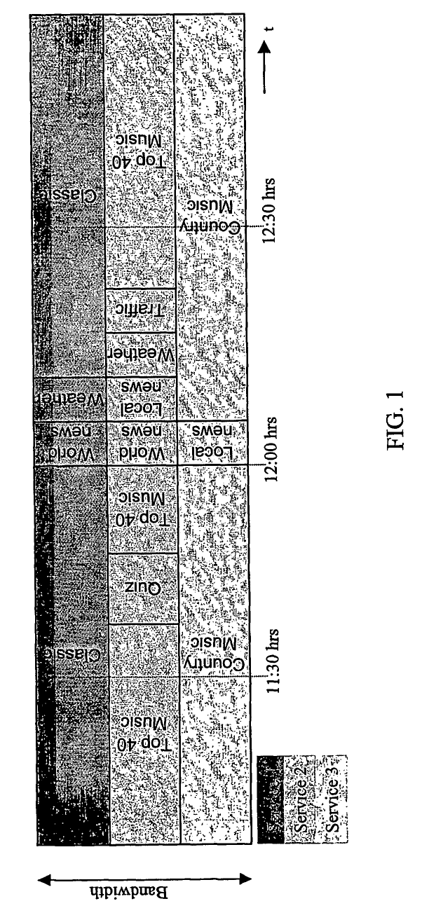

In conventional radio, a radio service is selected by the listener such that he selects from a relatively large number of stations one which offers a previously produced service which comes closest to his musical, entertainment and information wishes. To reach the greatest possible number of listeners, a broadcast radio station generally offers a number of sectional services fulfilling various listeners' requirements. By way of example, a broadcasting station as shown in FIG. 1 transmits a service 1 with classical music, world news and weather. In addition, a service 2 with top 40 music, quizzes, world/local news, weather and traffic is transmitted. Finally, the broadcasting station provides a service 3 which has country music and local news. In the horizontal plane, FIG. 1 shows the timing of the three services, and in the vertical plane, it shows the whole bandwidth available to the broadcasting station for service broadcasting, evenly split over the three services.

Conventional radio services thus have the drawback that they are relatively inflexible with respect to the requirements of the listeners. Hence, listeners with very individual wishes, for example who want country music and in-depth news, cannot be catered for with the indicated example services from the broadcasting station.

One approach to more individual shaping of listening to radio broadcasts is described in the periodical “c′t” year 2000 issue, No. 1, page 50, 3rd column. This deals with an “Internet radio” in which the listener or user becomes the service director. Before turning on, the listener chooses the music which he would like to hear and stipulates the commentary he would like to be given in the breaks. Thus, quite individual combinations can be produced, such as classical and sport, jazz and computer news or rock and weather, since words and music can be chosen independently of one another. A predefined user profile thus provides the listener with the option of automatically changing over to another station at the end of a broadcast. However, the listener does not have the option of listening to two or more broadcasts transmitted at parallel times.

On the basis of the problems illustrated, the object of the present invention is to provide a transmission and reception device and also associated methods which the listener can use to fulfil his individual listener requirements better.

According to the invention, to this end, a transmission apparatus is provided for transmitting radio information using a data source for providing a multiplicity of data packets for data transmission, and a transmitter device for transmitting the multiplicity of data packets at parallel times, where, in addition, a classification device is provided for classifying each data packet to be transmitted in a prescribed multiplicity of information classes, according to the respective information content, and a data processing installation is provided for arranging the data packets in each information class in relation to a respective data stream, so that a multiplicity of data streams corresponds to the multiplicity of information classes.

Using such a transmission apparatus allows better utilization of the available total channel capacity if the individual broadcasts are transmitted, sorted by information classes, in a transmission channel having a matched bandwidth. This allow a news channel having a very narrow bandwidth to be produced, for example. Thus, information transmissions do not need to be transmitted using the same bandwidth, such as classical music, as in the case of conventional radio. Similarly, other broadcasts can also be combined on the basis of their information class and can be transmitted using a bandwidth matched on the basis of the information class. The bandwidths of the individual transmission channels can thus be designed to be variable, which allows a reduction in the total bandwidth or an increase in the number of transmission channels.

In the case of further developments of the transmission apparatus according to the invention, the data processing installation comprises a device for providing one or more transmittable user profiles which can be used for reproduction control of the data streams for receiver apparatuses with respect to time. Such user profiles, which are transmitted by the broadcasting station, have the advantage that they offer professional compilation of a radio service, as in the case of conventional radio.

The present invention also provides an appropriate transmission method.

In addition, a reception apparatus is provided for receiving and conditioning radio information using a receiver device for receiving data streams, comprising one or more data packets, from a plurality of transmission channels, and a data processing device for individually forwarding the data packets to a reproduction device, where the receiver device is designed for simultaneously receiving the data streams from a plurality of transmission channels, and the data processing device has a memory which can buffer-store data packets of the data streams from the receiver device, so that the data packets forwarded to the reproduction device comprise data directly from the receiver device and/or data from the memory. Advantageously, the memory option allows the listener to compile his individual radio service. In this context, he can also listen to broadcasts transmitted simultaneously by storing one or more broadcasts and reading them from the memory and listening to them at a later time. In addition, he can also listen to stored broadcasts more than once. This means that the broadcasting station can save channel capacity, because it only needs to transmit certain broadcasts, such as news, once in each update period.

In advantageous developments, listeners can create dedicated user profiles or receive them from the broadcaster. These user profiles are used to control the forwarding of the data packets to the reproduction device. Specific forwarding of the data packets can consist in special record scripts controlling the buffer-storage and in playback scripts controlling the reading of the data packets or broadcasts from the memory.

One particularly advantageous use of the inventive transmission and reception apparatus can be expected for Internet radio.

The present invention is now explained in more detail with reference to the appended drawings, in which:

FIG. 1 shows a time chart for a radio service based on the prior art;

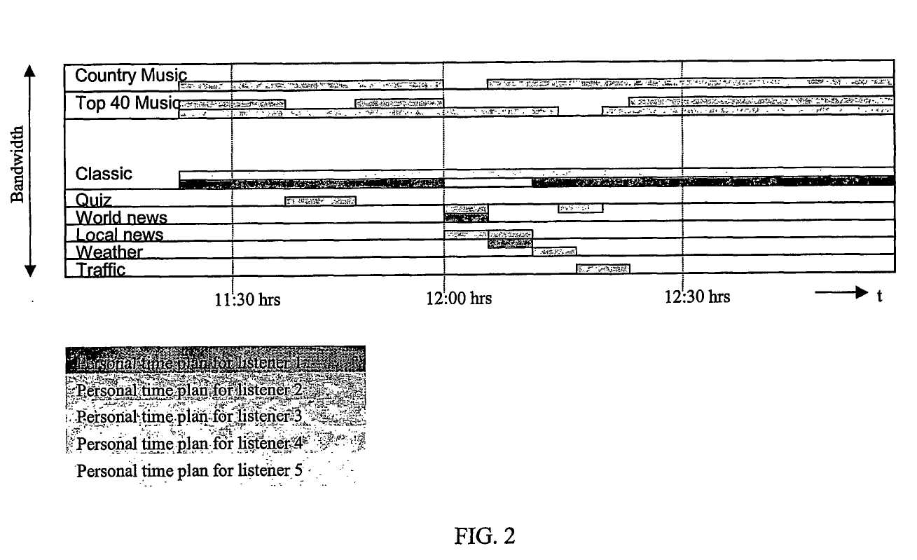

FIG. 2 shows a time chart for a radio service based on the present invention;

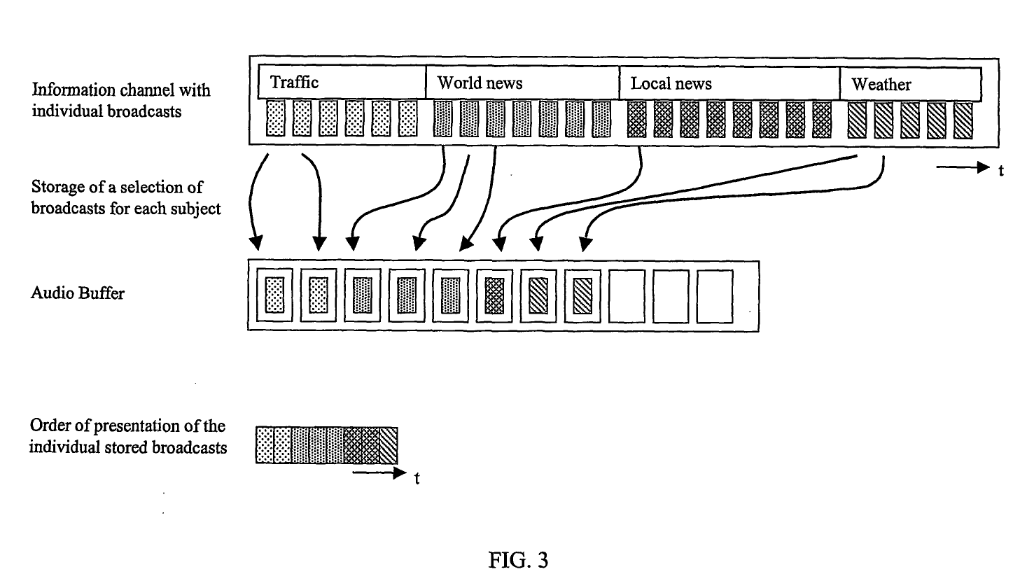

FIG. 3 shows a schematic chart for the individual structuring of a radio service; and

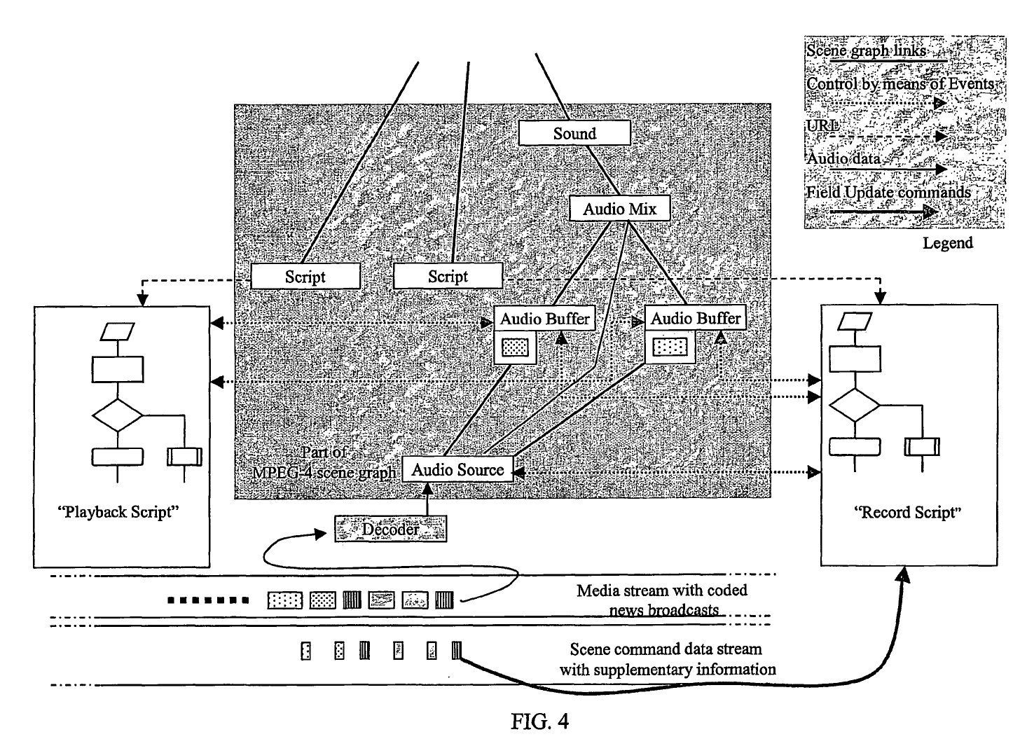

FIG. 4 shows a block diagram of the inventive method for creating an individual radio service.

The exemplary embodiment below is used to give a better understanding of the present invention.

Following the broadcasts on offer shown in FIG. 1, in accordance with the invention, a broadcasting station provides this multiplicity of broadcasts in information classes in parallel on the transmission bandwidth available to it. In the present example, the classes comprise country music, top 40 music, classical music, quiz shows, world news, local news, weather reports and traffic reports. In this regard, FIG. 2 shows a timing chart, with the bandwidth of the individual transmission channels also being indicated. The total transmission bandwidth available to the broadcasting station can be used in optimum fashion, because, when digital coding methods are used, speech can be transmitted at a lower data rate than, by way of example, country music, and this in turn can be transmitted at a lower data rate than classical music. The distribution of the transmission bandwidths is not limited to the example above. Instead, by way of example, the transmission bandwidth for country music can also be chosen to be the highest. The end user or the listener can now compile his personal radio service on his special digital reception/decoding equipment in the form of a flowchart which, by way of example, offers him top 40 music in the morning, presents the world news at 12:15 p.m. and then continues to play top 40 music again.

Comparing FIGS. 1 and 2 reveals that, for the same total bandwidth, the invention allows more channels, in particular voice channels, to be provided. This plurality of transmission channels provides the listener with a greater number of selection options for compiling his dedicated service.

The voice channels shown in FIG. 2 can be filled with further broadcasts, which do not necessarily have to be situated in the music channels' breaks in transmission, because the listener has memories, “AudioBuffers”, available for recording individual broadcasts. Thus, if a piece of classical music is transmitted in the classical channel, for example, and at the same time world news is transmitted in a news channel, then the user can record the world news in the AudioBuffer and can listen to it at the end of the piece of classical music. The listener is thus no longer limited to listening to radio broadcasts at the same time as they are transmitted.

The inventive classification of the radio broadcasts and the transmission of, each class's broadcasts in a respective transmission channel with a matched bandwidth also allows the total bandwidth available to a broadcasting station to be reduced. In the present example shown in FIG. 2, this can be seen immediately, because the speech broadcasts can be transmitted in 1 to 2 channels instead of 5 channels. This would allow the total bandwidth to be reduced by at least 3 voice channels.

Such a scenario can be produced, by way of example, on the basis of the object-oriented MPEG-4 standard. In accordance with this standard, various coding methods for speech and music are provided for different quality levels and data rates. The presentation of the individual contents received in parallel can be influenced on the decoder or terminal. This allows not just an exclusive selection from the transmitted contents to be presented, but also a mixture thereof. Thus, the presentation form for news can also be prescribed with or without background music, for example, in a user profile.

Instead of now providing various news channels having different subject focuses in parallel, as indicated in FIG. 2, and allowing the listener to have the news presented using a time plan, it is also possible to provide a single channel which transmits all the current news broadcasts once over the course of a period to be defined. The audio buffer standardized in MPEG-4 can now be used to store a selection of individual news broadcasts from various categories, such as world news, local news, weather and traffic, in the decoder and then to play it back at the desired time on the basis of the user profile, as shown in FIG. 3.

The broadcasting stations can thus use a comparatively small transmission bandwidth to provide a multiplicity of services which are based on the same “raw data” and hence provide a large number of listeners with a more individual service than previously. The listener can thus tailor the compilation and presentation of the contents of broadcasts to his own requirements.

The described service compilation by the listener and the provision of the associated prerequisites by the broadcaster are not limited to normal radio systems in which data transmission takes place via radio or RF broadband cable. Instead, the advantage of individual service compilation can also be used for other transmission methods, e.g. over Internet connections. In principle, the inventive individual service compilation can also be used when transmitting other data streams which have not actually been produced specifically for one user. That is to say that the present invention can be used not just for “normal” radio and MPEG-4, but also for SMIL, for example.

Individual service structuring using user profiles is explained in more detail below with reference to FIG. 4.

A user profile essentially comprises a data record which contains information about the content preferences of a listener and desired timings. One or more such data records could, by way of example, be created using a separate module, sometimes even graphically, and could be supplied to the terminal using a non-volatile storage medium. A software program in the terminal then needs to decide which parts of the incoming data need to be presented at what time, on the basis of the data record and using incoming supplementary information about the content of the transmitted broadcasts.

In one implementation of the invention on the basis of the MPEG-4 standard, a user profile can be regarded as a variation or modification of an MPEG-4 scene transmitted by the broadcaster. An MPEG-4 scene describes which incoming audio or video streams need to be presented in what way and at what time. In addition, user activities and “Script Nodes” can be used to make alterations to the scene. It is thus possible to provide a profile in the form of a Script which is incorporated into the MPEG-4 scene using the Script Node. Such Scripts for controlling the AudioBuffer are shown at the left-hand and right-hand edges of the image in FIG. 4. The “Record Script” is a command and data record for controlling the recording of data packets in one or more audio buffers. By contrast, the “Playback Script” is used for controlling the playback times of the data packets or broadcasts stored in the individual audio buffers.

Since the broadcasts are transmitted sequentially and selective playback is intended to be possible, the terminal needs to be able to record selected broadcasts. Appropriate memories need to be provided for this purpose. In addition, supplementary information needs to be accessible which allows a decision to be made regarding whether or not broadcasts which are currently being transmitted need to be recorded. Such supplementary information can also be provided by the broadcasting station.

A user-configurable software program in the terminal can then use supplementary information transmitted in parallel with the services to make the decision regarding storage or buffer-storage on the basis of the presets in the user profile. In this context, a log needs to be made, for example in the form of tables, regarding which memory area is storing which broadcast, in order to permit subsequent specific access. A further user-configurable software program can then be used to stipulate the playback times and orders in a Playback Script.

In one implementation based on MPEG-4, a respective “AudioBuffer Node” can be used for storing individual broadcasts. Recording and reproduction can be controlled using user-configurable Script Nodes.

Since no supplementary information about the content, such as genre or category, length, input time etc., can be stored within an AudioBuffer Node, this is done for each node in data fields of the Script Node. In addition, at the start of a new broadcast, the features thereof are stored in further fields of this Script Node, namely the Record Script shown at the right-hand edge of the image in FIG. 4, using supplementary information called Scene Update commands.

The rest of the method proceeds as follows. The updated data fields are evaluated using the Record Script. Execution of the Script can be triggered by means of an event, e.g. a clock pulse from a timer or TimerSensor Node which has likewise been configured using a Scene Update command indicated at the bottom of FIG. 4. On the basis of the user profile stipulations, a decision is made regarding whether the broadcast needs to be stored. If the broadcast needs to be stored, it is first ascertained which AudioBuffer Node is available for storage. To this end, a table or an array, for example, is used to establish which AudioBuffers are intended to record broadcasts from this category at all. Next, it is necessary to ascertain from the possible candidates, possibly using a table, the one which is still unoccupied or holds the previously least important or oldest broadcast in memory. This broadcast is then erased or is allowed to be overwritten, e.g. by setting the “Length” field in the AudioBuffer Node to zero. The features Length, starting time etc. need to be updated in the table. Finally, recording can be started by setting the “Length” field in the selected AudioBuffer Node to the broadcast's length, transmitted with the features.

The broadcasts or data packets are now played back using a further Script, namely the Playback Script shown at the left-hand edge in FIG. 4. This Script is created and configured by the user or listener, but may equally also be provided by the broadcaster. The Playback Script stipulates when and with what degree of regularity which AudioBuffers need to be played back from which category. A connected Timer Sensor Node is used to check on a regular basis whether a time for playing back broadcasts has been reached. The table from the Record Script Node is now used to ascertain the AudioBuffer Nodes which need to be played back. On the basis of the length details from the feature table, start and stop times for the successive broadcasts can be ascertained and entered into the fields of the appropriate AudioBuffer Nodes. Specific playback of individual broadcasts at any desired time can also be made possible by means of user activities, e.g. pressing an appropriately allocated button.

In summary, in the case of this MPEG-4 implementation, data from the media stream are thus supplied for further processing by a decoder. In interaction with the Scene Command data stream, which is supplied by the broadcaster and contains supplementary information relating to broadcasts in the form of FieldUpdate commands, the Record Script and the Playback Script control the storage and reading of broadcasts or data packets in or from one or more AudioBuffers. An audio mixer receives the audio data either under time control from AudioBuffers or “live”, so to speak, from the decoder and produces a corresponding audio signal.

1. Transmission apparatus for transmitting radio information using
a data source for providing a multiplicity of data packets for data transmission, and
a transmission device for transmitting the multiplicity of data packets at parallel times, characterized by
a classification device for classifying each data packet to be sent in a prescribed multiplicity of information classes according to the respective information content, and
a data processing installation for arranging the data packets in each information class in relation to a respective data stream, so that a multiplicity of data streams corresponds to the multiplicity of information classes.

2. Apparatus according to claim 1, where the data processing installation comprises a device for providing one or more transmittable user profiles which can be used for reproduction control of the data streams for receiver apparatuses with respect to time.

3. Apparatus according to claim 1 or 2, where the transmission device is designed for transmitting data streams in transmission channels having bandwidths associated with the respective data streams.

4. Apparatus according to claim 3, where the data packets can be classified into the information classes News, Country and Classical by the classification device, and the bandwidth of a transmission channel for data streams in the News information class is smaller than that for Country, and this in turn is smaller than that for Classical.

5. Apparatus according to one of claims 1 to 4, where the transmission device is designed for transmitting the data streams via at least one radio link and/or a network, in particular the Internet.

6. Method for transmitting radio information using the following steps:
a multiplicity of data packets for radio transmission are provided,
each data packet to be sent is classified in a prescribed multiplicity. of information classes according to the respective information content,
the data packets in each information class are arranged in relation to a respective data stream, so that a multiplicity of data streams corresponds to the multiplicity of information classes, and
the multiplicity of data streams are sent at parallel times.

7. Method according to claim 6, having the further step of transmitting one or more user profiles which can be used for reproduction control of the data streams for receiver apparatuses with respect to time.

8. Method according to claim 6 or 7, where each of the data streams is sent in a transmission channel having a bandwidth associated with the respective data stream.

9. Method according to claim 8, where the data packets are classified into the information classes News, Country and Classical, and the bandwidth of the transmission channel for data streams in the News information class is smaller than that for Country, and this in turn is smaller than that for Classical.

10. Method according to one of claims 6 to 9, where the data streams are sent via at least one radio link and/or a network, in particular the Internet.

11. Reception apparatus for receiving and conditioning radio information using
a receiver device for receiving data streams, comprising one or more data packets, from a plurality of transmission channels, and
a data processing device for individually forwarding the data packets to a reproduction device,
characterized in that
the receiver device is designed for simultaneously receiving the data streams from a plurality of transmission channels, and
the data processing device has a memory which can buffer-store data packets of the data streams from the receiver device, so that the data packets forwarded to the reproduction device comprise data directly from the receiver device and/or data from the memory.

12. Apparatus according to claim 11, additionally having an input device for inputting a user profile which can be used for automatically controlling the forwarding of the data packets to the reproduction device.

13. Apparatus according to claim 11 or 12, where one or more user profiles can be received by the receiver device and can be stored in the data processing device for automatically controlling the forwarding of the data packets to the reproduction device.

14. Apparatus according to one of claims 11 to 13, where the receiver device is designed for receiving the data streams via at least one radio link and/or a network, in particular the Internet.

15. Apparatus according to one of claims 11 to 14, where the user profile comprises a Record Script for controlling the buffer-storage of the data packets and a Playback Script for controlling the reading of the data packets from the memory.

16. Method for receiving and conditioning radio information using the following steps:
data streams comprising one or more data packets are received from a plurality of transmission channels at the same time,
predetermined data packets of the received data streams are buffer-stored,
the data packets are forwarded directly after reception thereof and/or after buffer-storage thereof to a reproduction device.

17. Method according to claim 16, where the data packets are forwarded to the reproduction device by means of control using at least one user profile.

18. Method according to claim 16 or 17, where one or more user profiles are received or provided besides the data streams and are used for controlling the buffer-storage and/or forwarding.

19. Method according to one of claims 16 to 18, where the data streams and/or user profiles are received via at least one radio link and/or a network, in particular the Internet.

20. Method according to one of claims 16 to 19, where the user profile comprises a Record Script for controlling the buffer-storage of the data packets and a Playback Script for controlling the reading of the data packets after buffer-storage.
